(19) United States
(12) Patent Application Publication
(10) Pub. No.: US 2021/0361012 A1
(43) Pub. Date: Nov. 25, 2021

(54) Disposable Protective Garment And Barrier film

(71) Applicant: Henry G. Schirmer, Spartanburg, SC (US)

(72) Inventor: Henry G. Schirmer, Spartanburg, SC (US)

(21) Appl. No.: 17/231,062

(22) Filed: Apr. 15, 2021

Related U.S. Application Data
(60) Provisional application No. 63/027,715, filed on May 20, 2020.
(60) Provisional application No. 63/116,965, filed on Nov. 23, 2020.
(60) Provisional application No. 63/123,588, filed on Dec. 10, 2020.

(51) Int. Cl. A42B 1/04; A42B 1/019; A42B 1/008

(52) U.S. Cl. CPC A42B 1/04; A42B 1/008; A42B 1/019

(57) ABSTRACT

A disposable protective garment for positioning over a wearer's head is provided for use in airplanes, busses, trains, other mass transit and other single-use applications. The disposable protective garment includes a hood formed of tubular blown film that has an at least partly closed top that rests on a wearer's head and an open bottom that rests on a wearer's shoulders. A mask can be integrated into the hood by forming a plurality of apertures in the hood and placing a polymer fabric that acts as a filter over the plurality of apertures. The hood may alternatively be combined with a crown or air filter material positioned over its top; a tubular filter equipped with an electric fan that draws air from above, filters it and directs the clean air downward across the wearer's face; and/or headgear. A barrier film suitable for use in the protective garment as well as other barrier applications is also provided.

### RELATED APPLICATIONS

This patent application claims priority based on U.S. Provisional Application 63/027,715, filed on May 20, 2020; U.S. Provisional Application 63/116,695, filed on Nov. 23, 2020; and U.S. Provisional Application 63/123,588, filed on Dec. 10, 2020. The disclosures of these provisional applications are incorporated herein by reference.

### FIELD OF THE INVENTION

This present invention is directed to a disposable protective garment for positioning over a wearer's head, desirably for use in airline travel, bus and subway travel, voting booths, convention halls and other temporary use applications. The invention is also directed to a protective barrier film that can be used to make the disposable protective garment and also has other uses involving barrier properties.

### BACKGROUND OF THE INVENTION

The coronavirus pandemic has generated a need or desire for masks, gloves and other protective equipment that limit exposure between a user and his or her surrounding environment. Conventional masks can be both awkward and uncomfortable for the consumer-wearer, often requiring adjustment to allow enough air flow for breathing and to minimize fogging of glasses. Because conventional masks are typically held in place by loop attachments that encircle the wearer's ears, there is no one size that fits all users and protection is limited to due to variations in size of the users' heads and distance between users' faces and ears. There is also an inverse relationship between the flow of air needed for comfortable breathing and the amount of protection provided by the mask. If the mask is adjusted to enable comfortable breathing, the degree of protection is reduced. If the mask is adjusted to provide maximum protection, the flow of air is inhibited to make breathing difficult and uncomfortable. Masks that are designed to provide both high protection and more comfortable breathing are typically too expensive for everyday consumer use and/or for disposal after a single use. Moreover, masks that are designed for multiple uses can accumulate bacteria and virus growth within the masks, thereby defeating their purpose to a large degree.

There is a need or desire for a protective item that is inexpensive, effective, and designed for disposal after a single use.

There is also a need or desire for an inexpensive disposable protective item that provides adequate protection from viruses and bacteria without significantly interfering with the wearer's breathing.

There is also a need or desire for a protective item that operates in cooperation with the flow of air in airplanes, busses, trains and other mass transit to inhibit viruses and bacteria from entering the protective item and affecting its user.

### SUMMARY OF THE INVENTION

The present invention is directed to a low-cost disposable protective garment for positioning over a wearer's head that is lightweight, easy to store and distribute, and can, if desired, be disposed of and recycled after a single use. The disposable protective garment is comfortable to the wearer, provides a clear path of vision, and provides ease of breathing while protecting the user from external viruses and bacteria as well as protecting others from the user's own breathing.

In one embodiment, the invention is directed to a disposable protective garment for positioning on a wearer's head that includes the following elements:

a protective hood formed of a tubular film and having an at least partially closed or covered top end and a slanted open bottom end;

the top end further including at least one of an uncovered open portion, one or more openings in a covered portion, and a porous cover material for receiving inlet air and passing it from the top end to the bottom end;

the slanted bottom end being open to receive a wearer's head.

The foregoing disposable protective garment can be combined and/or integrated with a mask, a rigid or semi-rigid crown, an inlet air filter and/or a fan-driven tubular filter as described below and can also include a headgear. In another embodiment, the invention is directed to a disposable protective garment that includes the following elements:

a protective hood formed of a tubular film and having a filtered top end and a slanted open bottom end;

the top end being at least partially closed or covered to rest on top of a wearer's head;

the top end further including an air filter material for filtering air received through the top end, at least partially covering the top end;

the slanted bottom end being open to receive the wearer's head.

In another embodiment, the invention is directed to a transparent multilayer coextruded film for use in forming a disposable protective garment. The transparent multilayer film includes the following elements:

first and second outer layers formed using a transparent polyester or polyester copolymer;

an inner layer formed using a low density polyethylene or linear low density polyethylene having low crystallinity; and

adhesive layers between each of the two outer layers and the inner layer;

wherein the film has a light transmission of at least about 80%.

With the foregoing in mind, it is a feature and advantage of the invention to provide a disposable protective garment for positioning on a wearer's head that is lightweight, inexpensive, disposable, and useful in a wide variety of mass transit application and other single use applications.

It is also a feature and advantage to provide a disposable protective garment for positioning on a wearer's head that provides ample protection to the wearer and others around him or her without creating inconvenience and discomfort.

The foregoing and other features and advantages will become further apparent from the following detailed description of the invention, read in conjunction with the drawings.

### BRIEF DESCRIPTION OF THE DRAWINGS

FIG. 1 is a side view of one embodiment of a disposable protective garment of the invention that includes a hood combined with a mask.

FIG. 2 is a front view of the protective hood and mask combination of FIG. 1.

FIG. 3 is schematic side view of the disposable protective garment of FIG. 1, on a wearer.

FIG. 4 is schematic front view of the disposable protective garment of FIG. 1, on a wearer.

FIG. 5 is a side view of another embodiment of a disposable protective garment of the invention, including a protective hood equipped with a top crown to maintain distance between the protective hood and the wearer's face.

FIG. 6 is a front view of the disposable protective garment of FIG. 5.

FIG. 7 is a top view of one embodiment of the disposable protective garment of FIG. 5 in which the crown partly covers the top of the protective hood and leaves an open portion for receiving air.

FIG. 8 is a top view of another embodiment of the disposable protective garment of FIG. 5 in which the crown completely covers the top of the protective hood and has vent openings for receiving air.

FIG. 9 is schematic front view of an embodiment of the disposable protective garment including a protective hood combined with an air filter material and positioned on a wearer.

FIG. 10 is schematic side view of the disposable protective garment of FIG. 9, positioned on a wearer.

FIG. 11 is a top view of the disposable protective garment of FIG. 9.

FIG. 12 is schematic front view of an embodiment of the disposable protective garment including a protective hood combined with an air filter material as in FIG. 9, further combined with a fan-powered tubular air filter and positioned on a wearer.

FIG. 13 is schematic side view of the disposable protective garment of FIG. 12, with the air filter removed to show details of the fan-powered tubular filter and positioned on a wearer.

FIG. 14 is a top view of the protective hood, air filter and fan-powered tubular filter of FIG. 12.

FIG. 15 is a schematic front view of a basic disposable protective garment of the invention, including a protective hood, and positioned on a wearer.

FIG. 16 is a schematic side view of the protective disposable protective garment of FIG. 15, positioned on a wearer.

FIG. 17 is a top view of the disposable protective garment of FIG. 15.

FIG. 18 is a schematic front view of the disposable protective garment of FIG. 15 combined with a hat or helmet and positioned on a wearer.

FIG. 19 is a schematic side view of the disposable protective garment of FIG. 15 combined with a hat or helmet and positioned on a wearer.

FIG. 20 schematically illustrates one cost-effective method of supplying the disposable protective hood component of the protective garment of the invention.

### DETAILED DESCRIPTION OF THE INVENTION

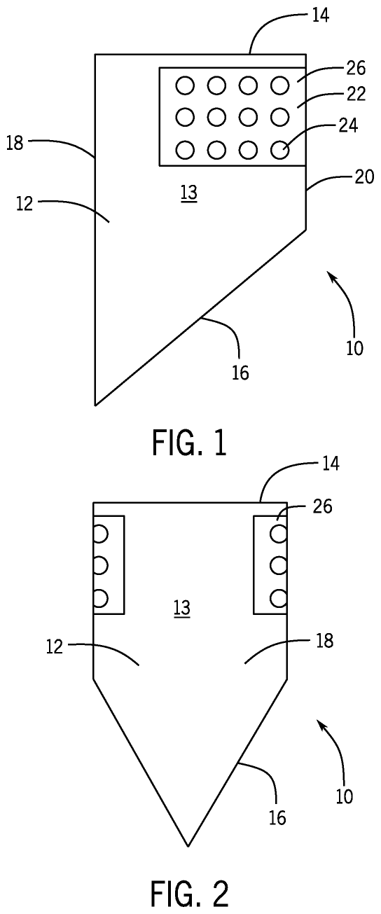

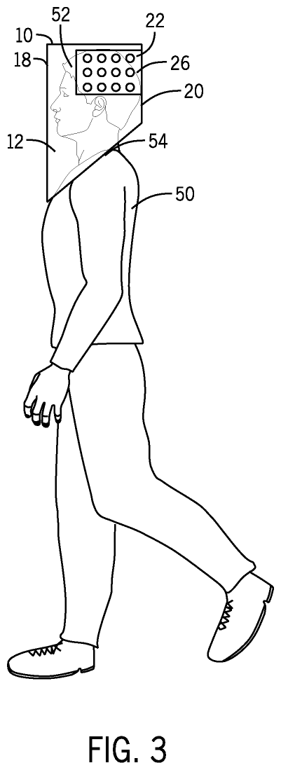

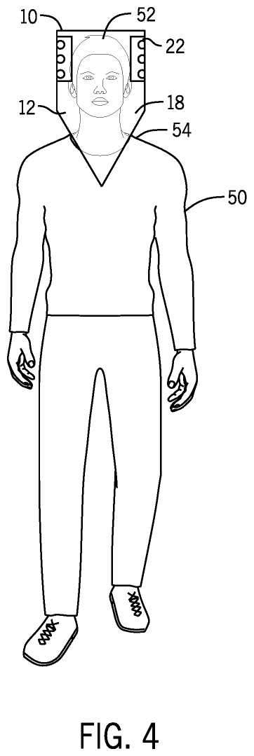

Referring to FIGS. 1 and 2, a disposable protective garment 10 of the invention includes a protective hood 12 formed of a tubular plastic film 13 having an at least partially closed or covered top end 14 and a slanted open bottom end 16. The top end 14 is designed to rest on the top of a head 52 of a wearer 50 as shown in FIGS. 3 and 4. The slanted bottom end 16 is open so as to receive the wearer's head 52 and can rest on the wearer's shoulders 54 during use as shown in FIGS. 3 and 4. When the hood and mask combination 10 is positioned upright as shown in FIG. 1, the bottom end 16 is slanted at an angle of about 25 to about 75 degrees from horizontal, suitably about 30 to about 60 degrees from horizontal, or about 40 to about 50 degrees from horizontal. As a result, the slanted bottom end 16 and the top end 14 define a longer front side 18 and a shorter back side 20 of the hood 12. The front side 18 may have a length that is about 1.1 to about 3 times the length of the back side 20, suitably about 1.5 to about 2.5 times the length of the back side 20, or about 2 times the length of the back side 20. This allows the slanted bottom end 16 to fit comfortably on a wearer's shoulder, whereupon the force of gravity urges the front side 18 slightly away from the wearer's face so as not to block the wearer's breathing passages.

Airplanes, commercial busses, trains and other large mass transit carriers often blow fresh and/or filtered air from the top of the cabin and downward toward each passenger. The hood and mask combination 10 is suitably designed to work in cooperation with this clean air flow. Accordingly, the top end 14 of the hood 12 is typically partially opened and partially closed or covered to enable the hood to receive the clean air flow while maintaining the position of the hood 12 on the wearer's head. The partial closure can be formed by heat sealing the tubular film 14 to itself, by gluing, by threading and tightening a ribbon or string through the top end 14, or by any suitable technique. The top end can also be partially twisted shut to leave a partial opening, or completely twisted shut followed by slitting to leave a partial opening. The top end 14 of the hood 12 is suitably about 25% to about 75% closed or covered and about 25% to about 75% opened, or about 40% to about 60% closed or covered and about 40% to about 60% opened. The open portion of the top end 14 can be located toward the front side 18 of the hood 12 so that the clean air from the top of the cabin is directed through the opening and toward the wearer's face, or can be located toward the back side 20 of the hood 12 to provide a more tortuous path for the clean air before it reaches the wearer's face.

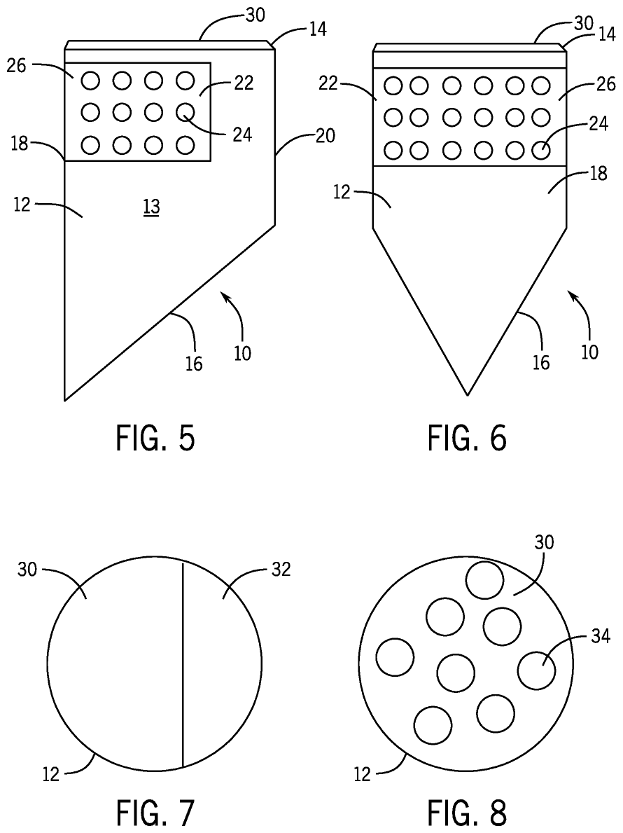

FIGS. 5 and 6 illustrate an alternative embodiment of the disposable protective garment in which the top end 14 of the hood 12 is at least partially covered with a rigid or semi-rigid crown 30. The purpose of the crown 30 is to prevent the front of the hood 12 from collapsing against the skin of the wearer's face. The crown 30 may cover only part of the top end 14 as shown in FIG. 7 so as to leave an uncovered, open portion 32 for receiving clean air flow. In this embodiment, the hood 12 can suitably be positioned so that the open portion 32 of the crown 30 is positioned adjacent to either the front or the back of the wearer's head. Alternatively, the crown 30 may cover the entirety of the top end 14 as shown in FIG. 8, in which case the crown 30 can have its own opening or openings 34 for receiving clean air flow. The openings 34 can be fairly evenly distributed throughout the crown 30 or can be positioned in only a portion (e.g., the front, back and/or side regions) of the crown 30. The crown 30 can be formed as a polymer film, such as a polyester film or other material, which has suitable thickness and rigidity to maintain a distance between the front of the hood 12 and the wearer's face, so that the hood 12 does not collapse. The crown 30 can be affixed to the top end 14 of the hood 12 using heat sealing (e.g., heat and pressure), adhesive lamination, stitching, sewing and/or other suitable techniques.

The slanted open bottom end 16 of the hood 12 provides enhanced protection of the wearer's face by minimizing any backflow of air through the bottom end towards the wearer's face and breathing passages. Due to the clean air being directed downward from the top of the mass transit cabin, the flow of clean air through the hood 12 is typically from top to bottom. However, the open bottom end 16 can nevertheless permit some backflow, especially when the wearer disengages of blocks the flow of clean air from above. The longer front side 18 of the hood 12 which results from the slanted bottom end 16 minimizes the amount of backflow that reaches the wearer's face. In one embodiment, a ribbon or string (not shown) can be threaded through at least a portion of the slanted bottom end 16 and can be tightened to pull the longer front side 18 of the bottom end 16 of the hood 12 closer to the wearer.

A mask 22 is combined with the hood 12 by forming a plurality of apertures 24 in the hood, suitably in a rectangular pattern as shown. A filter material 26, which can be a strip of polymer fabric, is bonded to the tubular plastic film 13 that defines the hood 12 by heat sealing, gluing, or another suitable attachment technique. The filter material 26, which can be a rectangular strip as shown, completely covers the apertures 24 and the regions immediately surrounding the apertures 24. The mask 22 is thus defined by the plurality of apertures 24 in the tubular film 13 and the laminated filter material 26 covering the apertures 24. A first strip of filter material 26 can be bonded to one of the inside and the outside surface of the tubular film 13. If desired, a second strip of filter material 26 can be bonded to the other of the inside and the outside surface of the tubular film 13 to provide improved filtration.

The apertures 24 can be circular as shown, square, rectangular, oval, elliptical, of can have any suitable shape. The apertures 24 should be large enough to enable free passage of air yet small enough so as not to interfere with the structural integrity of the hood 12. Depending on their shape, the apertures 24 can have a diameter, length, or other dimension ranging from about 0.1 inch to about 1.5 inch, suitably about 0.5 inch to about 1.0 inch. The mask 22 can be positioned on the front side 18 of the hood 12 as shown in FIGS. 5 and 6 and can be positioned to cover the user's face and nose. Alternatively, the mask 22 can be positioned on the back side 20 of the hood 12 as shown in the FIGS. 1 and 2. The mask 22 can function as a vent whereupon clean air entering from the top 14 and exhaled air from the wearer can circulate inside the hood 12 and exit through the mask 22. Regardless of its positioning, the mask 22 is advantageously large enough to encircle a substantial portion of the plastic tubular film 13 as shown in the drawings. In the embodiments shown in FIGS. 1, 2, 5 and 6, the mask 22 encircles more than half of the tubular film 13. In various embodiments, the mask 22 can encircle from about 30% to about 100% of the circumference of the tubular film 13, suitably about 40% to about 80%, or about 50% to about 75% of the circumference of the tubular film 13.

The tubular film 13 forming the hood 12 can be a coextruded film, such as coextruded barrier film that possesses moisture barrier and some air barrier. The coextruded film can include a barrier layer having a first side and a second side, a first heat seal layer on the first side of the barrier layer, and a first tie layer bonding the first heat seal layer to the barrier layer. Additionally, the coextruded film can have a second heat seal layer on the second side of the barrier layer and a second tie layer bonding the second heat seal layer to the barrier layer.

The barrier layer can be formed of a polyolefin that offers moisture barrier and suitable air barrier for the duration of use of the protective hood and mask combination 10. Suitable polyolefins include without limitation linear low-density polyethylene, linear medium density polyethylene, branched low density polyethylene, polypropylene, and combinations thereof. Linear low-density polyethylene is particularly suitable for most applications.

The first heat seal layer and, if included, the second heat seal layer can be formed using a polyester copolymer. Suitable polyester copolymers include without limitation polyethylene terephthalate glycol, polyethylene terephthalate-1,4-cyclohexane-2 methyl ester, polyester-polyether block copolymers, and combinations thereof. Polyethylene terephthalate glycol (PETG) is particularly suitable for one or both of the heat seal layers.

The first adhesive tie layer and, if included, the second adhesive tie layer can be formed of a soft polymer that exhibits tackiness. Suitable soft polymers include without limitation ethylene methyl acrylate, ethylene ethyl acrylate, ethylene methacrylic acid, ethylene ethyl acrylate, and combinations thereof. Ethylene methyl acrylate and ethylene ethyl acrylate are particularly suitable for one or both of the adhesive tie layers.

The filter material 26 used to form the mask 24 can be formed using a polymer fabric. Suitable polymer fabrics include without limitation polyester fabrics, polyamide fabrics, cellulose fabric, and combinations thereof. Polyester fabrics are particularly suitable.

In a relatively simple embodiment, the protective hood need only include a tubular film 13, suitably having a partly closed top end 14 for resting on a wearer's head and an open bottom end 16 for resting on a wearer's shoulders. Adequate ventilation can be achieved by passing clean cabin air through the partly open top end, downward and out through the open bottom end. In simple and more complex embodiments, the tubular film 13 forming the hood 12 can have a more complex layer structure that provides comfort, clarity, relatively low cost and excellent heat seal properties. One exemplary complex layer structure includes a five-layer arrangement having two outer layers of polyester homopolymer or copolymer, and inner layer of polyethylene, and adhesive layers joining each of the outer layers to the inner layer. One suitable multilayer film includes the five-layer sequence PETG/EEA/PE/EEA/PETG. The PETG (polyethylene terephthalate glycol) is an amorphous polyester copolymer that provides high clarity and softness and is excellent for heat sealing. The EEA (ethylene ethyl acrylate) provides the film with adhesive tie layers for bonding the PETG on both sides to the PE (polyethylene) layer. The polyethylene layer can be a low density or linear low density polyethylene, suitably one that has low crystallinity. Conventional (branched) low density polyethylene resins typically have crystallinities ranging from about 35% to about 55%, measured using ASTM D1505, and densities of about 0.910 to about 0.925 grams/cm³. Linear low-density polyethylene resins typically have crystallinities ranging from about 35% to about 60% and densities of about 0.910 to about 0.925 grams/cm³. The polyethylene layer should be selected to have a crystallinity at the lower end of the range, suitably about 35% to about 45%, or about 35% to about 40%.

The polyethylene serves as the structural layer that provides the tubular film 13 with sufficient overall strength for its intended uses. Because of its low crystallinity, the polyethylene layer has low internal haze. When its surfaces are covered with the relatively clear EEA and PETG film layers, the overall tubular film 13 is very clear. Film clarity is a measure of percent light transmittance and can be measured using ASTM D1746. For example, when a film is exposed to 100% of an incident light source, the transmittance is 100% minus (percent absorption+percent reflection). For optimal use and wearer comfort, the tubular film 13 should have a light transmittance of at least about 80%, suitably at least about 84%, or at least about 88%.

The foregoing film can also be used as a barrier film having high transparency in a wide variety of barrier applications including, but not limited to the protective garment. In one embodiment, the barrier film can include an oxygen barrier layer such as an internal layer of ethylene vinyl alcohol, which can be positioned between the polyethylene structural layer and one of the outer polyester homopolymer or copolymer (e.g., PETG) layers. The ethylene vinyl alcohol (EVOH) layer is joined on both sides with an adhesive tie layer. The adhesive tie layer used to bond the EVOH can also be EEA but is suitably a blend of EEA and an anhydride-modified polyolefin, for example PLEXAR® available from MSI Technology, LLC. Adhesive blends can include about 25% to about 75% by weight EEA and about 25% to about 75% by weight anhydride-modified polyolefin, or about 40% to about 60% by weight of each component, or about 50% by weight of each component. Exemplary high barrier film structures that exhibit excellent clarity include without limitation PETG/adhesive blend/EVOH/adhesive blend/PE/EEA/PETG; PETG/EEA/PE/adhesive blend/EVOH/adhesive blend/PETG; and PETG/adhesive blend/EVOH/adhesive blend/PE/adhesive blend/PETG.

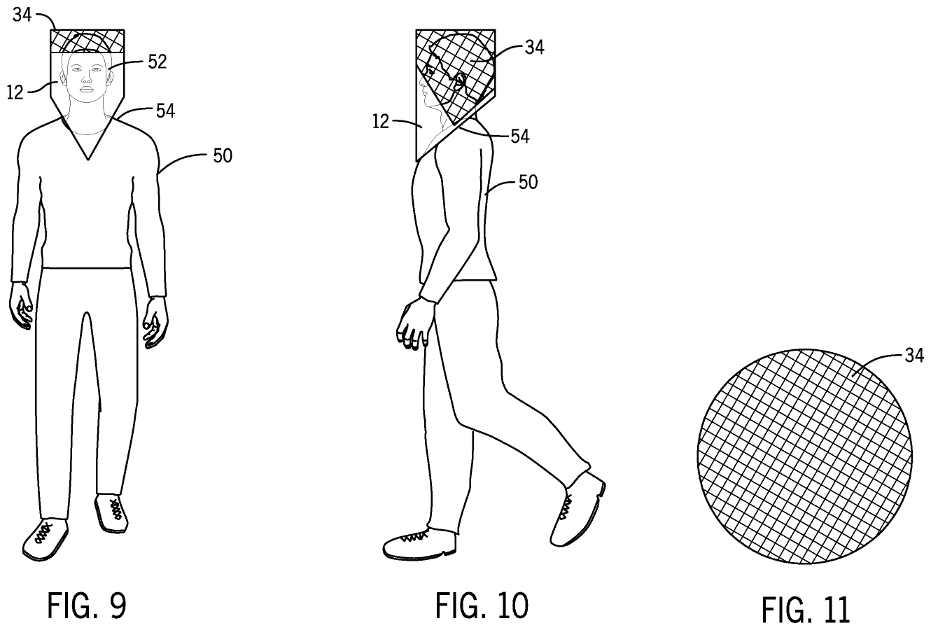

FIGS. 9-12 illustrate an alternative embodiment in which an air filter material 34 is disposed over the top end 14 of the hood 12 in place of, or in addition to the crown 30. The air filter material 34 can have a pore size small enough to provide anti-bacterial and anti-viral protection. For example, the pore size can range from about 0.01 to about 50 microns, suitably about 0.05 to about 25 microns, or about 0.1 to about 10 microns. The air filter material can be formed from a polymer fabric including polymer fibers such as polyester, polypropylene, rayon or the like, and combinations thereof. The polymer fabric can be a nonwoven fabric such as a spunbond fabric, a meltblown fabric, or a multilayer spunbond/meltblown combination including, for example, a spunbond/meltblown/spunbond layer combination. The polymer fabric can also be a woven fabric or a combination of woven and nonwoven layers. In one example, the air filter material can be a polyester fabric. In another, more complex example, the air filter material can include a top nonwoven layer of polyester and polypropylene, an intermediate nonwoven layer of cotton and polyethylene, and a bottom nonwoven layer of viscose and polypropylene.

A shown in FIGS. 9 and 10, the use of an air filter material 34 can, but does not necessarily have to enable elimination of the mask 22. The air filter material 34 can be used on combination with the hood 12, with or without the mask 22. When the hood 12 is used in an airplane cabin, the air filter material 34 filters and cleans the air that is blown downward toward the wearer from the top of the cabin. The air filter 34 can also be sized so that it not only covers the top end 14 of the hood 12 but extends downward along the front, sides and/or back of the hood 12 as shown in FIGS. 9 and 10. When used in this fashion, the air filter material 34 effectively replaces the mask and obviates its need, because the air filter material 34 will then encompass areas of the hood typically occupied by the mask and performs the functions of the mask.

The air filter material 34 can be attached to the hood 12 using heat sealing (e.g., heat and pressure), adhesive lamination, stitching, sewing and/or other suitable techniques. When the hood is formed using one or more outer heat seal layers as described above, such as the above-described five-layer arrangement of PETG/EEA/PE/EEA/PETG, the air filter material can be heat sealed or otherwise attached to the inside or the outside of the hood 12, or to both the inside and the outside of the hood 12.

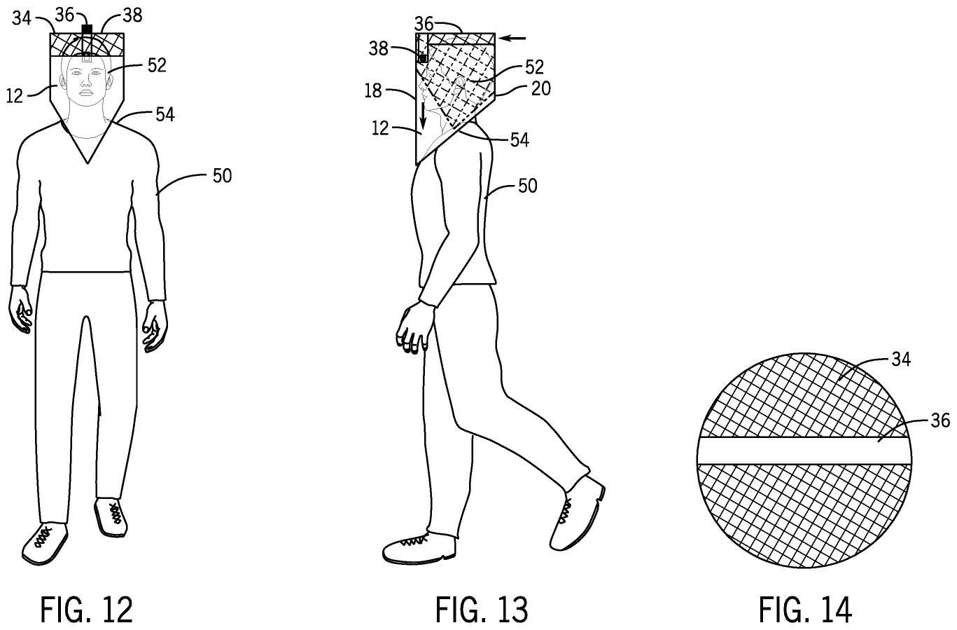

FIGS. 12-14 show an embodiment of the disposable protective garment similar to FIGS. 9-11, with the further addition of a filtering tube 36 and a battery-powered electric fan 38 located at a forward mouth of the tube 36. The tube 36 can be mounted at the top end 14 of the hood 12 and can be placed above or below the layer of filter material 34 or can be placed between two layers of filter material 34. The tube 36 can be rigid, semirigid or flexible and can be formed of any suitable material, including without limitation plastic materials such as low density polyethylene, linear low density polyethylene, high density polyethylene, polypropylene, polyester, polycarbonate, and others. The tube 36 can be at least partly filled with its own filtering material, such as cotton or another loose material, and can be L-shaped as shown and can be mounted so that its inlet end is above the top end 14 and near the back end of the hood 12, and its outlet (exit) end faces downward into the front of the hood 12. The electric fan 38 draws air from the rear entrance of the tube 36, through the tube and downward through its forward mouth as shown by the arrows in FIG. 13. The fan 38 and tube 36 thus operate together to control the flow of air, such as clean air from above, and directs the clean air downward across the wearer's face and through the bottom end 16 of the hood 12. This controlled air flow not only provides the wearer with a continuous supply of clean air, but also helps prevent unfiltered air from entering the hood 12 through its open bottom portion 16.

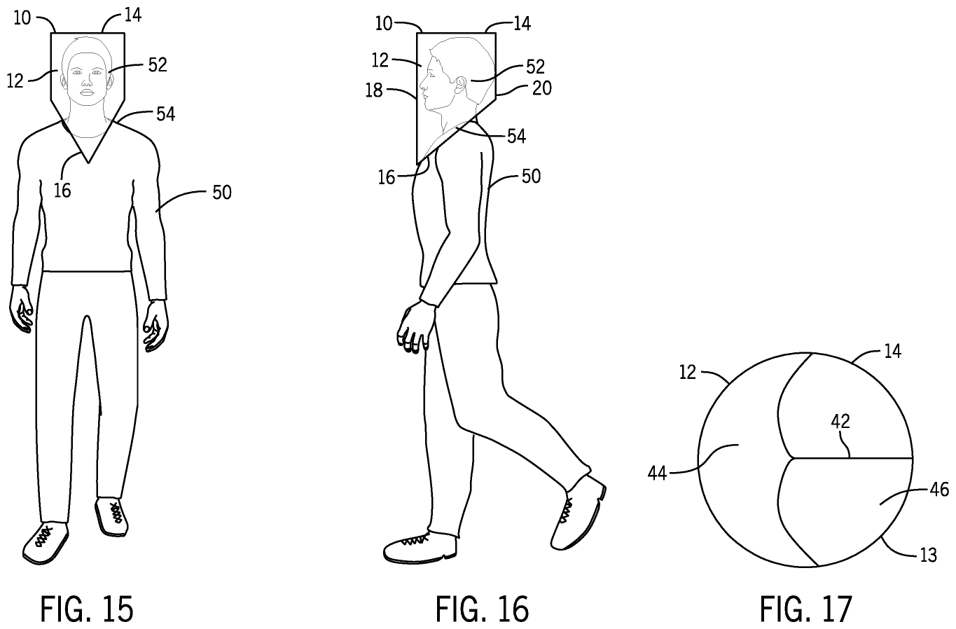

FIG. 13 omits the details of the filter material 34, in order to enable showing the details of the filtering tube 36 and the fan 38. However, the use of the filtering tube 36 and electric fan 38 is not limited to the embodiments that employ the filtering material 34. The filtering tube 36 and electric fan 38 can be used in connection with any embodiment of the current invention, including without limitation, the hood-and-mask embodiments shown in FIGS. 1-6, the “crown” embodiment of FIGS. 5-8, the “filter material” embodiment of FIGS. 9-11, and the “basic” embodiment described below with respect to FIGS. 15-17.

FIGS. 15-17 illustrate the most basic embodiment of a disposable protective garment 10, primarily based on the protective hood 12 in which the top portion 14 is partly open and is partly closed by a seal 42 so as to leave a closed region 46 nearer to the back 20 of the protective hood 12 and an opposing open region 44 nearer to the front 18 of the protective hood 12. In this embodiment, the plastic tubular film 13 is folded inward at the top 14 and from the back 20 to enable formation of the seal 42. The seal 42 can be a heat seal and can also be formed by other techniques such as adhesive bonding, stitching and sewing and the like. The seal 42 can alternatively be placed near the front 18 of the plastic tubular film 13 and the protective hood 12, so that the closed region 46 is nearer to the front 18 and the open region 44 is nearer to the back 20 of the protective hood 12. The protective hood 12 can be used in combination with a separate mask that covers the wearer's face, can be used in combination with any one or more of the foregoing integrated masks, crowns, filter materials, filter tube and fan, or can be used alone to provide a basic level of protection.

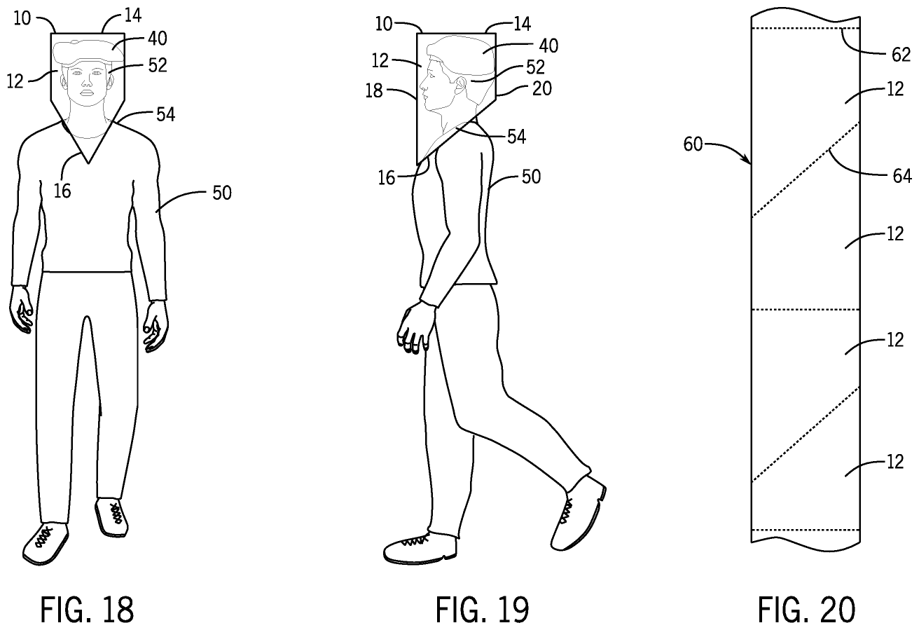

FIGS. 18 and 19 illustrate an embodiment in which the basic disposable protective garment of FIGS. 15-17 is combined with headgear 40 and positioned on a wearer. The headgear 40 can be positioned adjacent to the top end 14 of the hood 12 and can be a protective helmet, hat, stocking cap, scarf, or even a headband that serves a basic purpose of maintaining a comfortable distance between the front 18 of the protective hood 12 and the wearer's face. In one embodiment, the hood 12 can have an appropriate size, such as a larger size, that is sufficient to comfortably accommodate the headgear 40 and fit over the headgear 40. The protective garment 10 can thus be provided as a two-piece assembly that includes the headgear 40 and the protective hood 12. Alternatively the protective garment 10 can be provided as a single assembly in which the headgear 40 and protective hood 12 are connected together at one or more locations.

In embodiments of the protective garment 10 when the headgear 40 and protective hood 12 are either unconnected or connected together, the headgear can define the at least partially closed portion of the protective hood 12. In these embodiments, the protective hood 12 illustrated in FIG. 17 can be provided without the seal 42 because an analogous closed portion 46 is provided by the headgear 40. The headgear 40 can be either unconnected or connected at one or more intermittent locations around the perimeter of the protective hood 12 so that a) the headgear 40 closes the top end 14 and provides one or more air passage openings in the headgear (analogous to openings 34 in FIG. 8) and/or between the headgear 40 and the protective hood 12, and/or b) the headgear partially closes the top end 14 leaving an open portion (analogous to the open portion 32 in FIG. 8) for the passage of air. These embodiments of the protective garment 10 provide enhanced wearer comfort by eliminating the seal 42 (FIG. 17) so that the protective hood 12 is less confining. The headgear 40 can be fastened to the protective hood 12 at one or more intermittent locations using heat sealing, adhesive bonding, stitching and sewing, snapping, or any other suitable technique. Alternatively, the headgear 40 can remain unconnected to the protective hood 12, in which case the protective hood 12 is vertically supported by the wearer's shoulders as shown in FIGS. 18 and 19 and is held open and away from the wearer's face by the headgear 40.

The protective garment 10 can be provided as a two-piece assembly in which the protective hood 12 can remain unconnected or be temporarily connected to the headgear 40 at one or more intermittent locations using tape, glue, hook-and-loop fasteners, pins, or another temporary fastening means or device. In these embodiments, the headgear 40 can be re-used several times and the protective hood 12 can be replaced more frequently, such as after every use. In one embodiment, the protective garment 10 can be sold as a kit that includes one or a small number of headgears 40 and a much larger number of disposable protective hoods 12. Whereas one function of the headgear 40 is to maintain adequate distance between the protective hood 12 and the user's face, the components can be sized and shaped so that the protective hood 12 fits over the headgear 40. Whereas one function of the protective garment 10 is to prevent the protective hood 12 from sliding downward across the user's face, the protective hood 12 can either be designed with a seal 42 as shown in FIG. 17, fastened at one or more intermittent locations to the headgear 40 as described above, or remain unconnected to the headgear whereupon the slanted bottom portion 16 of protective hood 12 is supported by the wearer's shoulders.

By maintaining a suitable distance between the front 18 of the hood 12 and the wearer's face, ventilation within the protective garment 10 can be greatly improved. Fogging of the protective hood 12 due to a wearer's exhaled breath can be minimized or eliminated. Talking can become clearer without the muted or muffled effect that a mask or clinging film may create. The combination of protective hood 12 and headgear 40 also creates a more tortuous path for air entering through the open region 44 of the top 14 of hood 12 (FIG. 17). The tortuous path ma between the hood 12 and headgear 40 makes it less likely for the wearer to inhale aerosols emitted from another person. The path can be made more tortuous by instead placing the seal 42, (FIG. 17), partially closed region 46, or other partially closed or partially covered region near the front of the hood 12, so that the open region 44 is placed near the back of the hood 12. In addition to the embodiments described above, in which the headgear is combined with the “basic” protective garment of FIGS. 15-17, the headgear 40 can be used in combination with and made part of any protective garment of the invention, including without limitation any the hood-and-mask embodiments shown in FIGS. 1-6, the “crown” embodiment of FIGS. 5-8, the “filter material” embodiment of FIGS. 9-11 and the “tube and fan” embodiment of FIGS. 12-14.

The protective hood 12 can be formed using a standard blown film process which forms a continuous tubular film and typically flattens the film between rollers. FIG. 20 illustrates a continuous tubular film 60 which is flattened and then cut into individual protective hoods 12 by making a series of alternating straight cuts 62 and slanted cuts 64 in the flattened tubular film. The cuts 62 and 64 can be continuous, so as to completely separate the protective hoods 12 from each other, whereupon the protective hoods 12 can be processed further as described in the various embodiments above and re-opened into tubes. Alternatively, the straight and slanted cuts 62 and 64 can be serrated or otherwise discontinuous as shown in FIG. 20. In the embodiment shown, the flattened tubular film 60 can be supplied as a continuous roll that includes more than 25, more than 50, more than 100 or any larger number of protective hoods 12. The individual protective hoods can then be separated from the tubular film 60 by tearing them away along the discontinuous cuts 62 and 64 in much the same fashion as individual paper towels are torn away from a roll. Once separated, the protective hoods 12 can be opened into tubes and processed as described above.

While the embodiments of the invention described herein are exemplary, various modifications and improvements can be made without departing from the spirit and scope of the invention. The scope of the invention is defined by the appended claims and all changes that fall within the meaning and range of equivalents are intended to be embraced therein.

1-30. (canceled)

31. A transparent multilayer coextruded film, comprising:
first and second outer layers formed using a transparent polyester or polyester copolymer;
a first inner layer formed using a low density polyethylene or linear low density polyethylene having low crystallinity; and
first and second adhesive layers between each of the two outer layers and the first inner layer;
wherein the film has a light transmission of at least about 80%.

32. The transparent multilayer film of claim 31, wherein the film has a light transmission of at least about 84%.

33. The transparent multilayer film of claim 31, wherein the film has a light transmission of at least about 88%.

34. The transparent multilayer film of claim 31, wherein at least one of the first and second outer layers comprises polyethylene terephthalate glycol.

35. The transparent multilayer film of claim 31, wherein both of the first and second outer layers comprise polyethylene terephthalate glycol.

36. The transparent multilayer film of claim 31, wherein the first inner layer has a crystallinity of about 35% to about 45%.

37. The transparent multilayer film of claim 31, wherein the first inner layer has a crystallinity of about 35% to about 40%.

38. The transparent multilayer film of claim 31, wherein the first and second adhesive layers comprise ethylene ethyl acrylate.

39. The transparent multilayer coextruded film of claim 31, further comprising a second inner layer formed using an ethylene-vinyl alcohol copolymer.

40. The transparent multilayer film of claim 39, further comprising a third adhesive layer adjacent to the second inner layer.

41. The transparent multilayer film of claim 39, wherein the third adhesive layer comprises ethylene ethyl acrylate.

42. The transparent multilayer film of claim 41, wherein the third adhesive layer further comprises an anhydride-modified polyolefin blended with the ethylene ethyl acrylate.

43. The transparent multilayer film of claim 42, wherein one of the first and second adhesive layers is adjacent to the second inner layer and further comprises an anhydride-modified polyolefin blended with the ethylene ethyl acrylate.

44. The transparent multilayer film of claim 31, wherein the film comprises the following layer structure: PETG/adhesive/EVOH/adhesive/PE/EEA/PETG, where PETG is polyethylene terephthalate glycol, EVOH is ethylene vinyl alcohol, PE is low density polyethylene or linear low density polyethylene, and EEA is ethylene ethyl acrylate.

45. The transparent multilayer film of claim 31, wherein the film comprises the following layer structure: PETG/EEA/PE/adhesive/EVOH/adhesive/PETG, where PETG is polyethylene terephthalate glycol, EVOH is ethylene vinyl alcohol, PE is low density polyethylene or linear low density polyethylene, and EEA is ethylene ethyl acrylate.

46. The transparent multilayer film of claim 31, wherein the film comprises the following layer structure: PETG/adhesive/EVOH/adhesive/PE/adhesive/PETG, where PETG is polyethylene terephthalate glycol, EVOH is ethylene vinyl alcohol, PE is low density polyethylene or linear low density polyethylene, and EEA is ethylene ethyl acrylate.
